(19) United States
(12) Patent Application Publication
(10) Pub. No.: US 2012/0325099 A1
(43) Pub. Date: Dec. 27, 2012

(54) MULTIBEAM EXPOSURE SCANNING METHOD AND APPARATUS, AND METHOD OF MANUFACTURING PRINTING PLATE

(75) Inventor: Ichirou Miyagawa, Ashigarakami-gun (JP)

(73) Assignee: Fujifilm Corporation, Tokyo (JP)

(21) Appl. No.: 13/582,295

(22) PCT Filed: Mar. 30, 2011
(86) PCT No.: PCT/JP2011/058660

§ 371 Date: Aug. 31, 2012

(30) Foreign Application Priority Data
Mar. 31, 2010 (JP) 2010-081888

(51) Int. Cl. B41C 3/00; G03B 27/42

(52) U.S. Cl. 101/401.1; 355/77; 355/53

(57) ABSTRACT

This invention is concerning a multibeam exposure scanning method and apparatus, and a method of manufacturing a printing plate. The problem to be solved is that the influence of the heat from adjacent beams accompanying multibeam exposure is effectively reduced, and a desired shape having a very small size is formed with high precision. The above problem is to be solved by a multi-beam exposure scanning method for engraving a surface of a recording medium by emitting a plurality of beams simultaneously from an exposure head to the recording medium, the exposure head having N levels (N being an integer equal to or greater than 2) of emitting outlet rows each having emitting outlets arranged at intervals of P in a sub scanning direction, the N levels being arranged at regular intervals in a main scanning direction perpendicular to the sub scanning direction, the respective levels being arranged so that respective projected emitting outlets are located at intervals of P/N when the respective emitting outlets are projected in the main scanning direction. The multibeam exposure scanning method includes: scanning the recording medium in the main scanning direction N times with the exposure head; and emitting beams to a first area from only the emitting outlet row of one level while sequentially switching the levels to emit beams for each main scanning operation, where the surface of the recording medium is divided into a target flat area to be maintained without engraving, the first area to be engraved with precision, and a second area that is the remaining area.

### TECHNICAL FIELD

The present invention generally relates to a multibeam exposure scanning method and a multibeam exposure scanning apparatus, and a method of manufacturing a printing plate. More particularly, the present invention relates to a multibeam exposure technique suitable for manufacturing a printing plate such as a flexographic plate, and a printing plate manufacturing technique that utilizes the multibeam exposure technique.

### BACKGROUND ART

There has been a disclosed technique by which concave portions are engraved on the surface of a plate material with the use of a multibeam head that is capable of simultaneously emitting a plurality of laser beams (Patent Literature 1). Where a plate is engraved through the multibeam exposure, it is extremely difficult to stably produce minute forms such as tiny dots and thin lines, due to the influence of heat from adjacent beams.

To counter such a problem, Patent Literature 1 suggests a structure that performs so-called interlace exposure to reduce the mutual thermal influence between adjacent beam spots in a beam spot row formed on the surface of a plate material. That is, Patent Literature 1 discloses a method by which a plurality of laser spots are formed on a surface of a plate material at intervals twice or longer than the engraving pitch equivalent to the engraving density, the interval between each two scanning lines formed in one exposure scanning operation is made longer, and scanning lines between the respective scanning lines are exposed in the second and later scanning operations.

### CITATION LIST

### Patent Literature

PTL 1 Japanese Patent Application Laid-Open No. 09-85927

### SUMMARY OF INVENTION

### Technical Problem

By the method disclosed in Patent Literature 1, however, to completely eliminate the influence of adjacent beams, the interval between each two beam positions on the surface of the plate material needs to be sufficiently longer than the beam diameter. In practice, it is necessary to secure an interval equivalent to several pixels (several lines) between each two scanning lines. Therefore, the aberration of the lens used in the imaging optical system becomes a problem. To form a beam row having accurate scanning line intervals by moving the head at intervals equivalent to the engraving pitch, the optical system becomes complicated, and many other restrictions exist in practice.

The present invention has been made in view of the above circumstances, and an object thereof is to provide a multibeam exposure scanning method and a multibeam exposure scanning apparatus that effectively reduce the influence of the heat from adjacent beams accompanying multibeam exposure and are capable of forming a desired shape having a very small size with high precision, and also provide a printing plate manufacturing method that utilizes the method and apparatus.

### Solution to Problem

To achieve the above object, a multibeam exposure scanning method of a first aspect is a multibeam exposure scanning method for engraving a surface of a recording medium by emitting a plurality of beams simultaneously from an exposure head to the recording medium, the exposure head having N levels (N being an integer equal to or greater than 2) of emitting outlet rows each having emitting outlets arranged at intervals of P in a sub scanning direction, the N levels being arranged at regular intervals in a main scanning direction perpendicular to the sub scanning direction, the respective levels being arranged so that respective projected emitting outlets are located at intervals of P/N when the respective emitting outlets are projected in the main scanning direction. The multibeam exposure scanning method includes: scanning the recording medium in the main scanning direction N times with the exposure head; and emitting beams to a first area from only the emitting outlet row of one level while sequentially switching the levels to emit beams for each main scanning operation, where the surface of the recording medium is divided into a target flat area to be maintained without engraving, the first area to be engraved with precision, and a second area that is the remaining area.

According to the invention of the first aspect, beams are emitted to the first area to be engraved with precision only from the emitting outlet row of one level while the levels to emit beams are sequentially switched for each main scanning operation. Accordingly, the influence of heat is reduced, and a desired shape can be formed with high precision.

As a second aspect, the multibeam exposure scanning method of the first aspect further includes emitting beams to the second area simultaneously from the emitting outlet rows of all the levels.

Accordingly, rough engraving can be performed on the second area with higher engraving efficiency.

As a third aspect, in the multibeam exposure scanning method of the first or second aspect, the first area is an area peripheral to the target flat area to be maintained without engraving.

Accordingly, precise engraving can be performed on the area peripheral to the target flat area, with the influence of heat being reduced.

As a fourth aspect, in the multibeam exposure scanning method of any one of the first to third aspects, the second area is an area peripheral to the first area.

Accordingly, rough engraving with higher engraving efficiency can be performed on the second area on which precise engraving does not need to be performed.

To achieve the above object, a multibeam exposure scanning apparatus of a fifth aspect is a multibeam exposure scanning apparatus that emits a plurality of beams simultaneously from an exposure head to a recording medium, and engraves a surface of the recording medium. This multibeam exposure scanning apparatus includes: the exposure head that has N levels (N being an integer equal to or greater than 2) of emitting outlet rows each having emitting outlets arranged at intervals of P in a sub scanning direction, the N levels being arranged at regular intervals in a main scanning direction perpendicular to the sub scanning direction, the respective levels being arranged so that respective projected emitting outlets are located at intervals of P/N when the respective emitting outlets are projected in the main scanning direction; a main scanning unit that causes the exposure head to scan the recording medium relatively in the main scanning direction; a sub scanning unit that causes the exposure head to scan the recording medium relatively in the sub scanning direction; a scan control unit that causes a sub scanning operation to be performed once every time a main scanning operation is repeated on the recording medium at least N times; and an exposure control unit that causes only the emitting outlet row of one level to emit beams to a first area while sequentially switching the levels to emit beams for each main scanning operation, and causes the emitting outlet rows of all the levels to emit beams to a second area, where the surface of the recording medium is divided into a target flat area to be maintained without engraving, the first area to be engraved with precision, and the second area that is the remaining area.

According to the invention of the fifth aspect, beams are emitted to the first area to be engraved with precision only from the emitting outlet row of one level while the levels to emit beams are sequentially switched for each main scanning operation. Meanwhile, beams are emitted to the second area from the emitting outlet rows of all the levels. With this arrangement, precise engraving with less influence of heat can be performed on the first area, and rough engraving with higher engraving efficiency can be performed on the second area.

As a sixth aspect, in the multibeam exposure scanning apparatus of the fifth aspect, the scan control unit causes a sub scanning operation to be performed once every time a main scanning operation is repeated on the recording medium (N+1) times, and, in the first-time main scanning operation, the exposure control unit does not cause the emitting outlet rows to emit beams to the first area, and causes the emitting outlet rows of all the levels to emit beams simultaneously to the second area.

With this arrangement, the influence of heat on the area peripheral to the target flat area can be reduced.

To achieve the above object, a multibeam exposure scanning apparatus of a seventh aspect is a multibeam exposure scanning apparatus that emits a plurality of beams simultaneously from an exposure head to a recording medium, and engraves a surface of the recording medium. This multibeam exposure scanning apparatus includes: an exposure unit that includes an imaging lens and the exposure head that is capable of emitting N levels (N being an integer equal to or greater than 2) of rows of beams that are emitted onto the recording medium at intervals of P in a sub scanning direction, the N levels being arranged at regular intervals in a main scanning direction perpendicular to the sub scanning direction, the exposure unit being capable of emitting beams so that main scanning lines extended in the main scanning direction from the locations of the respective emitted beams are located at intervals of P/N; a main scanning unit that causes the exposure unit to scan the recording medium relatively in the main scanning direction; a sub scanning unit that causes the exposure unit to scan the recording medium relatively in the sub scanning direction; a scan control unit that causes a sub scanning operation to be performed only for one main scanning line every time a main scanning operation is performed on the recording medium; and an exposure control unit that causes only the emitting outlet row of a predetermined level to emit beams to a first area, and causes the emitting outlet rows of all the levels to emit beams simultaneously to a second area, where the surface of the recording medium is divided into a target flat area to be maintained without engraving, the first area to be engraved with precision, and the second area that is the remaining area.

According to the invention of the seventh aspect, beams are emitted to the first area to be engraved with precision only from the emission outlet row of a predetermined level, and beams are emitted to the second area simultaneously from the emitting outlet rows of all the levels. Accordingly, precise engraving with less influence of heat can be performed on the first area, and rough engraving with higher engraving efficiency can be performed on the second area.

As a eighth aspect, in the multibeam exposure scanning apparatus of the seventh aspect, when the number of beams emitted onto the recording medium at the intervals of P in the sub scanning direction is T, the scan control unit causes sub scanning operations to be performed for (T×N−N) main scanning lines after N main scanning operations.

Accordingly, efficient engraving can be performed on the entire surface of the plate material.

To achieve the above object, a multibeam exposure scanning apparatus of a ninth aspect is a multibeam exposure scanning apparatus that emits a plurality of beams simultaneously from an exposure head to a recording medium, and engraves a surface of the recording medium. This multibeam exposure scanning apparatus includes: an exposure unit that includes an imaging lens and the exposure head that is capable of emitting N levels (N being an integer equal to or greater than 2) of rows of beams that are emitted onto the recording medium at intervals of P in a sub scanning direction, the N levels being arranged at regular intervals in a main scanning direction perpendicular to the sub scanning direction, the exposure unit being capable of emitting beams so that main scanning lines extended in the main scanning direction from the locations of the respective emitted beams are located at intervals of P/N; a cylindrical drum that holds the recording medium on its outer face or inner face; a main scanning unit that causes the exposure unit to scan the recording medium relatively in the main scanning direction by rotating the exposure unit or the drum; a sub scanning unit that causes the exposure unit to scan the recording medium relatively in the sub scanning direction; a scan control unit that causes sub scanning operations to be performed for N main scanning lines at a constant velocity while rotating the exposure unit or the drum N times; and an exposure control unit that causes only the emitting outlet row of a predetermined level to emit beams to a first area, and causes the emitting outlet rows of all the levels to emit beams simultaneously to a second area, where the surface of the recording medium is divided into a target flat area to be maintained without engraving, the first area to be engraved with precision, and the second area that is the remaining area.

According to the invention of the ninth aspect, beams are emitted to the first area to be engraved with precision only from the emission outlet row of a predetermined level, and beams are emitted to the second area simultaneously from the emitting outlet rows of all the levels. Accordingly, precise engraving with less influence of heat can be performed on the first area, and rough engraving with higher engraving efficiency can be performed on the second area.

Since there are emitting outlet rows not to be used for the first area, even if there is an emitting outlet having a problem in emitting a beam, beams should be emitted to the first area with the use of an emitting outlet row that does not include the problematic emitting outlet. Accordingly, engraving can be performed without a reduction in productivity.

As a tenth aspect, in the multibeam exposure scanning apparatus of the ninth aspect, when the number of beams emitted onto the recording medium at the intervals of P in the sub scanning direction is T, the scan control unit causes sub scanning operations to be performed for (T×N−N) main scanning lines after the drum has been rotated N times.

Accordingly, efficient engraving can be performed on the entire surface of the plate material by a combination of spiral exposure and intermittent feeding.

As a eleventh aspect, the multibeam exposure scanning apparatus of any one of fifth to tenth aspects further includes a power control unit that controls the powers of the beams. The power control unit controls the powers of the respective beams emitted from the emitting outlet row of only one level to become higher than the powers of the respective beams emitted simultaneously from the emitting outlet rows of all the levels.

Accordingly, the engraving depths and widths obtained when beams are emitted only from the emitting outlet row of one level can be made equal to the engraving depths and widths obtained when beams are emitted simultaneously from the emitting outlet rows of all the levels. In this manner, the continuity between the respective areas can be maintained.

As a twelfth aspect, in the multibeam exposure scanning apparatus of any one of fifth to tenth aspects further includes a power control unit that controls the powers of the beams. The power control unit controls the powers of the beams so that, in the second area, the powers of the beams emitted from the emitting outlets become lower toward the first area.

Accordingly, the second area can be engraved properly.

To achieve the above object, in a method of manufacturing a printing plate of a thirteenth aspect, a surface of a plate material is engraved by a multibeam exposure scanning method claimed in any one of the first to fourth aspects to obtain a printing plate, with the plate material being equivalent to the recording medium.

According to the invention of the thirteenth aspect, it is possible to obtain a printing plate on which precise engraving with less influence of heat and rough engraving with higher engraving efficiency have been performed.

### Advantageous Effects of Invention

According to the present invention, the influence of heat from adjacent beams accompanying multibeam exposure can be effectively reduced, and a desired shape having a very small size can be formed with high precision.

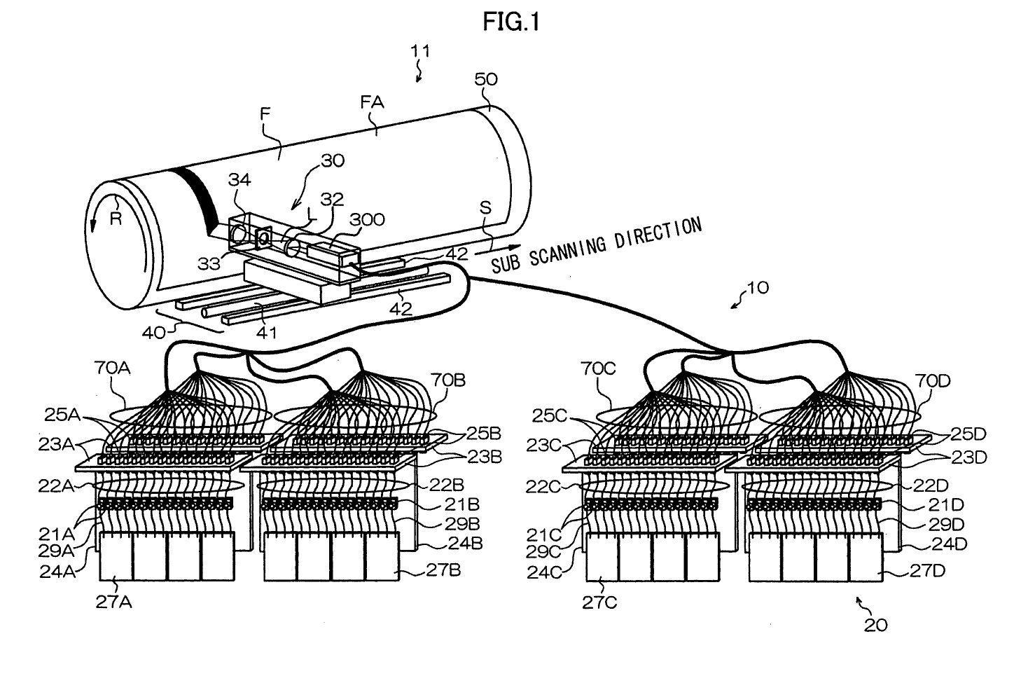

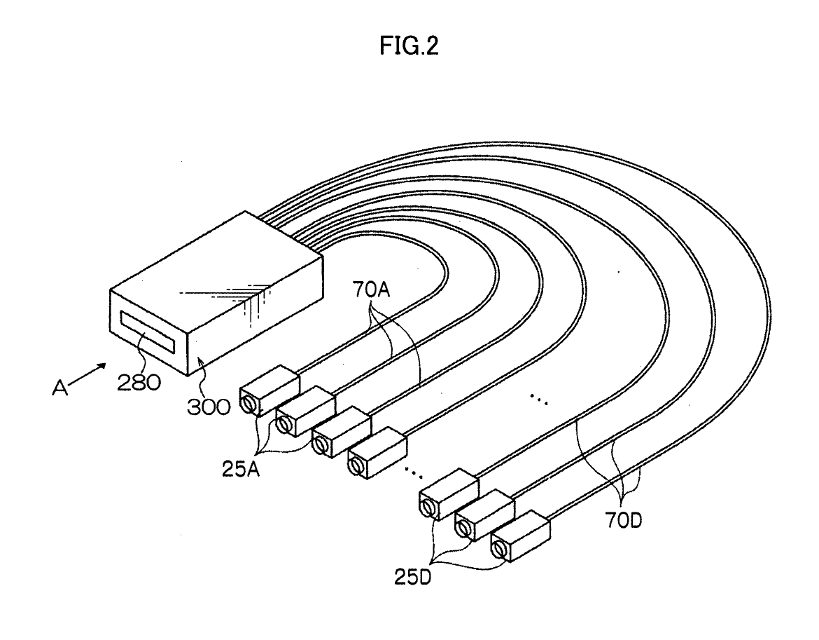

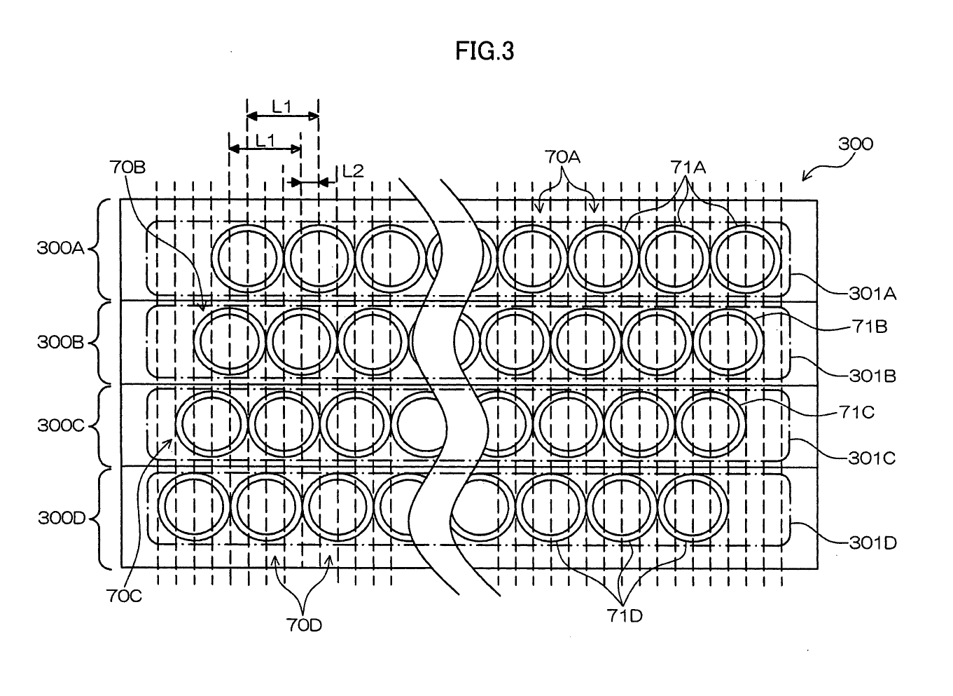

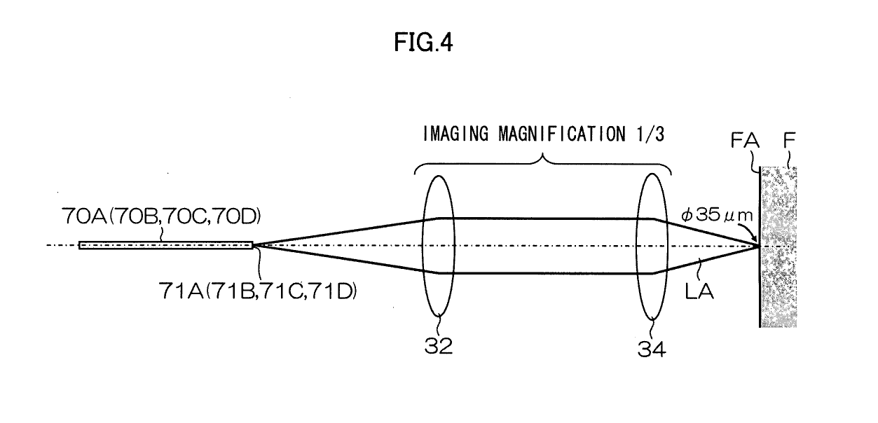

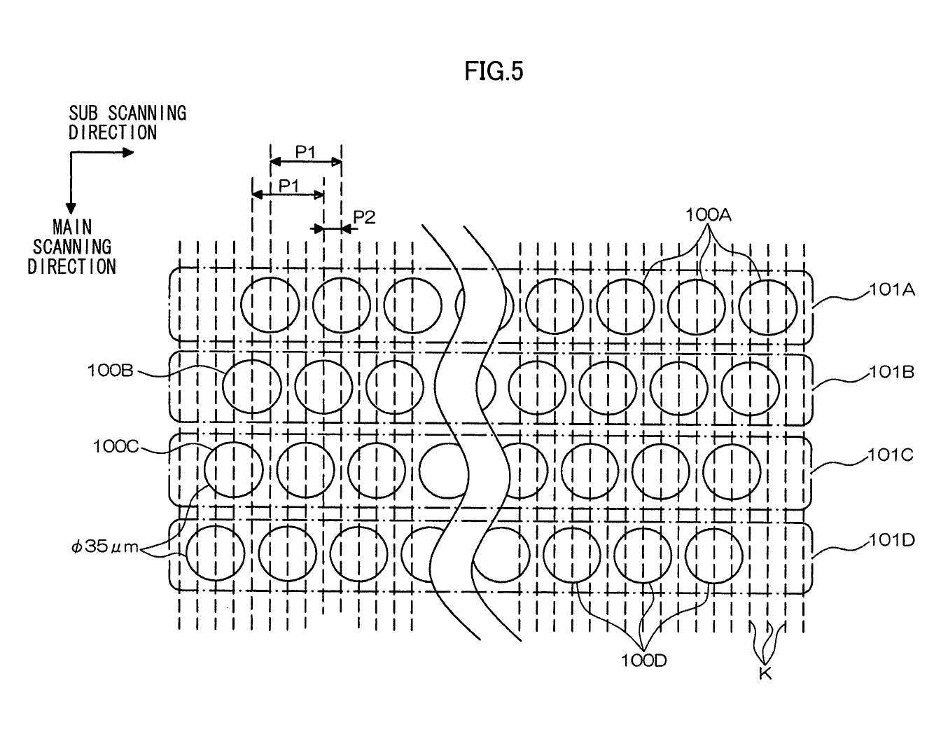

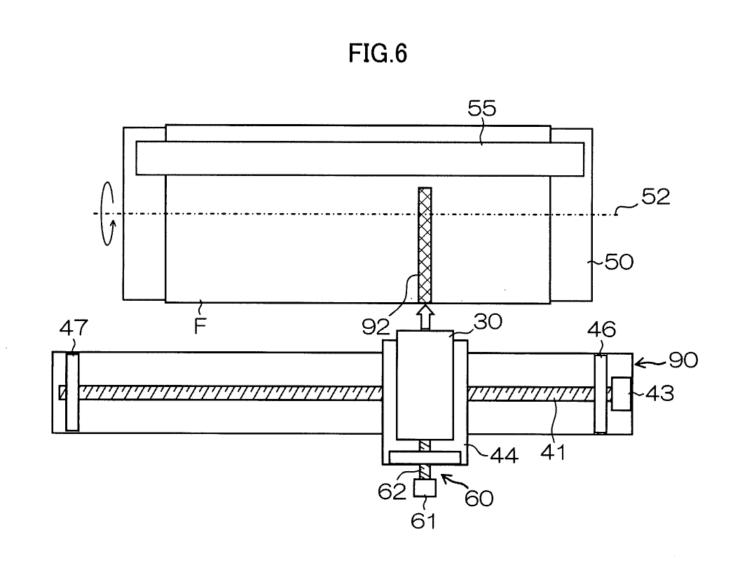

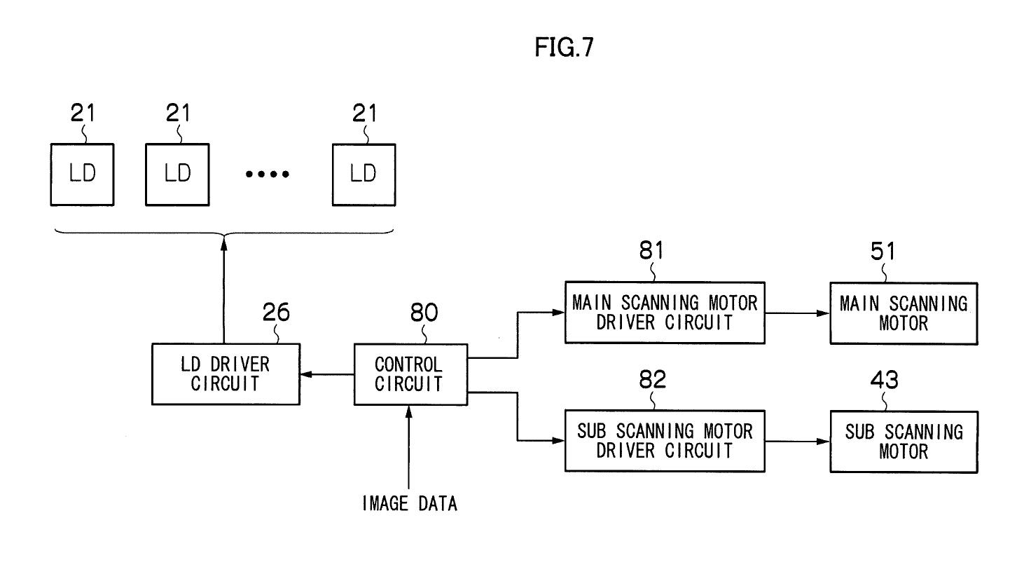

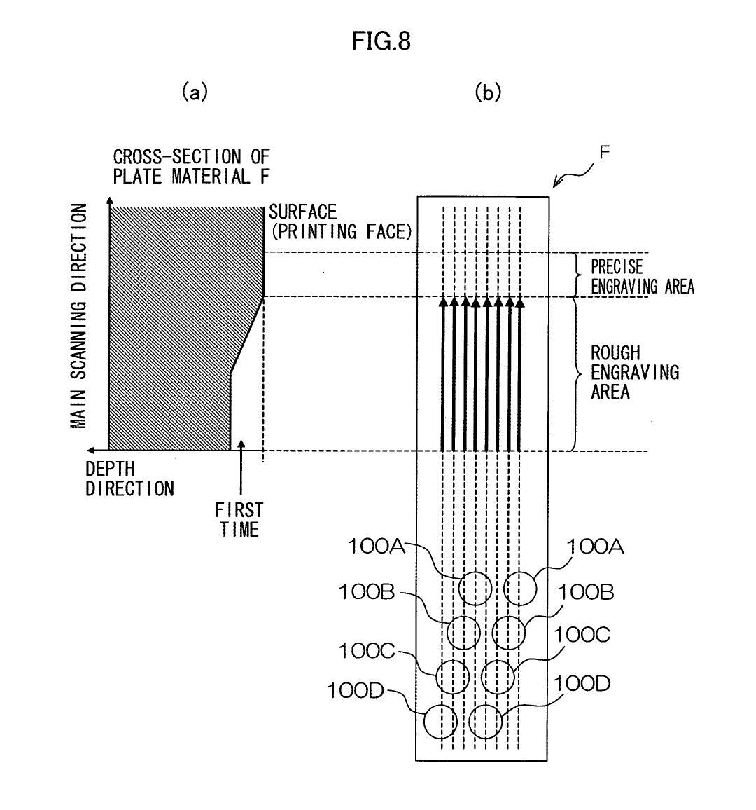

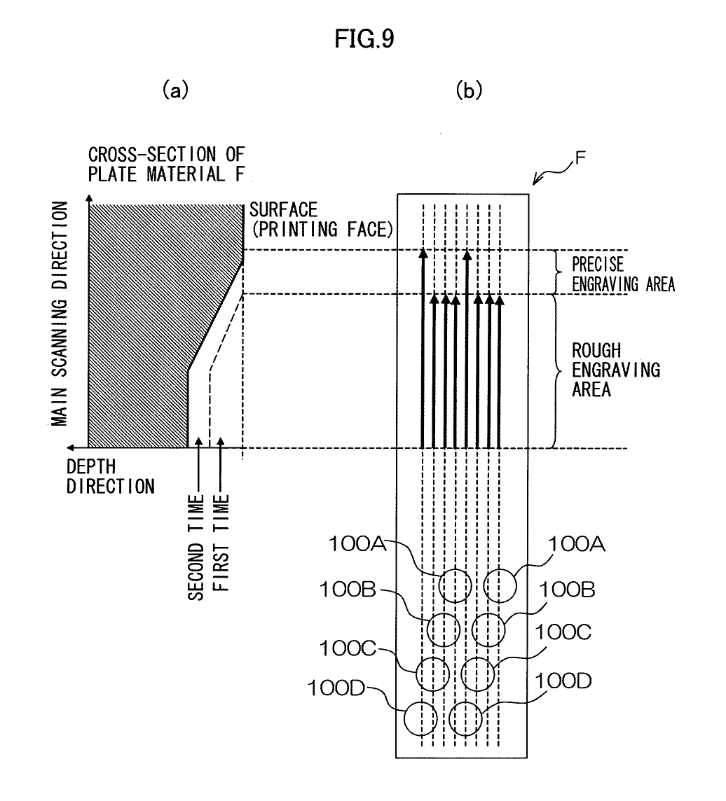

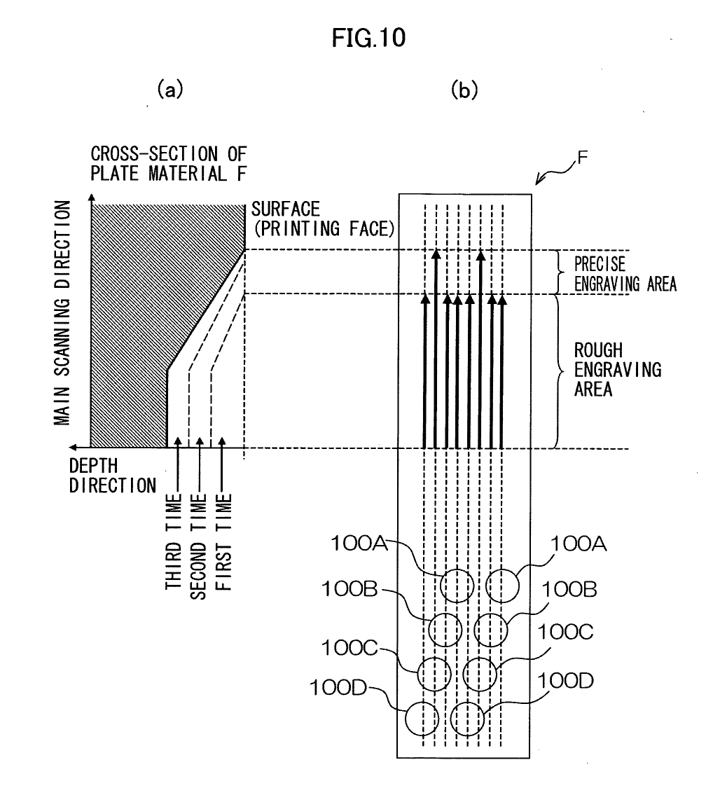

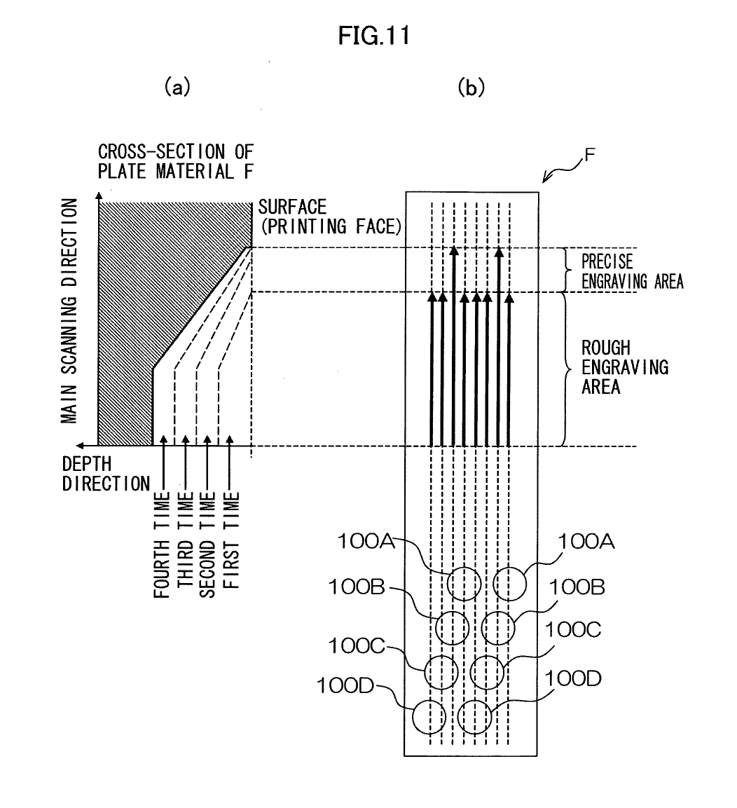

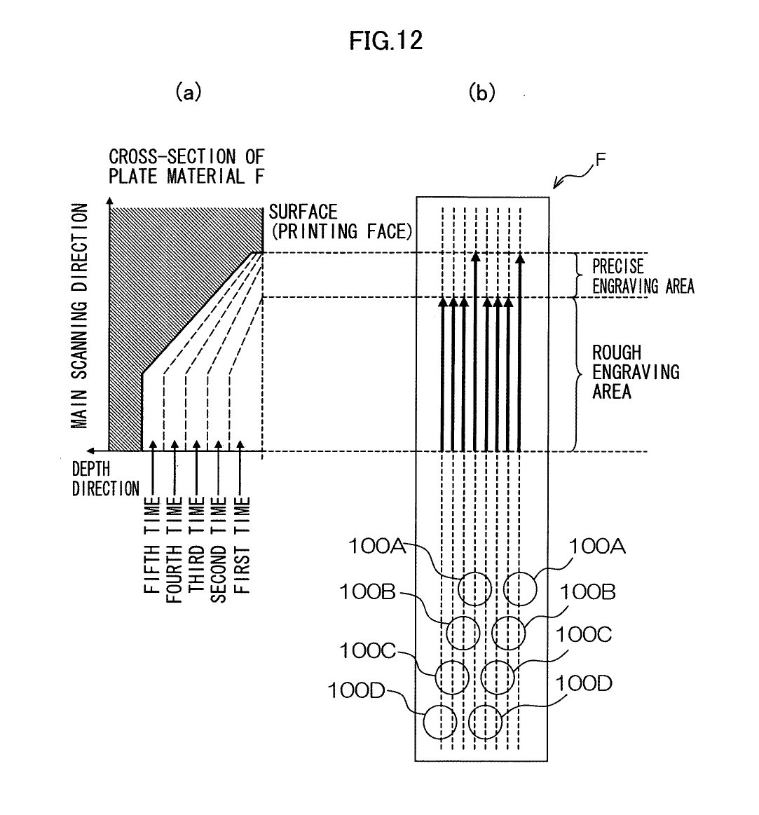

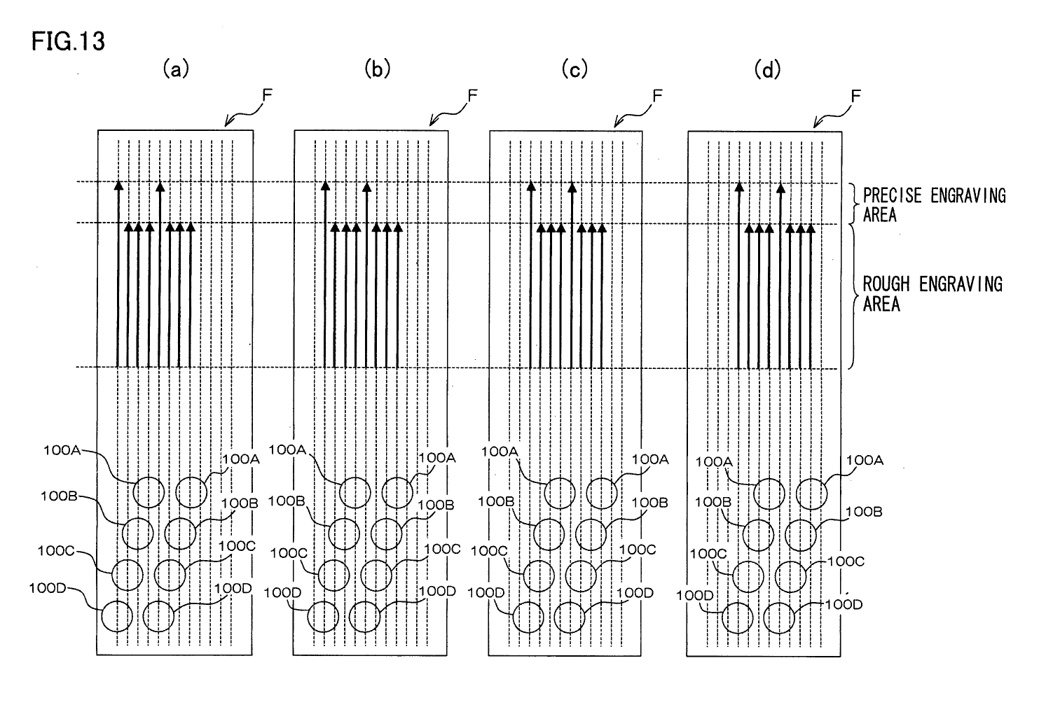

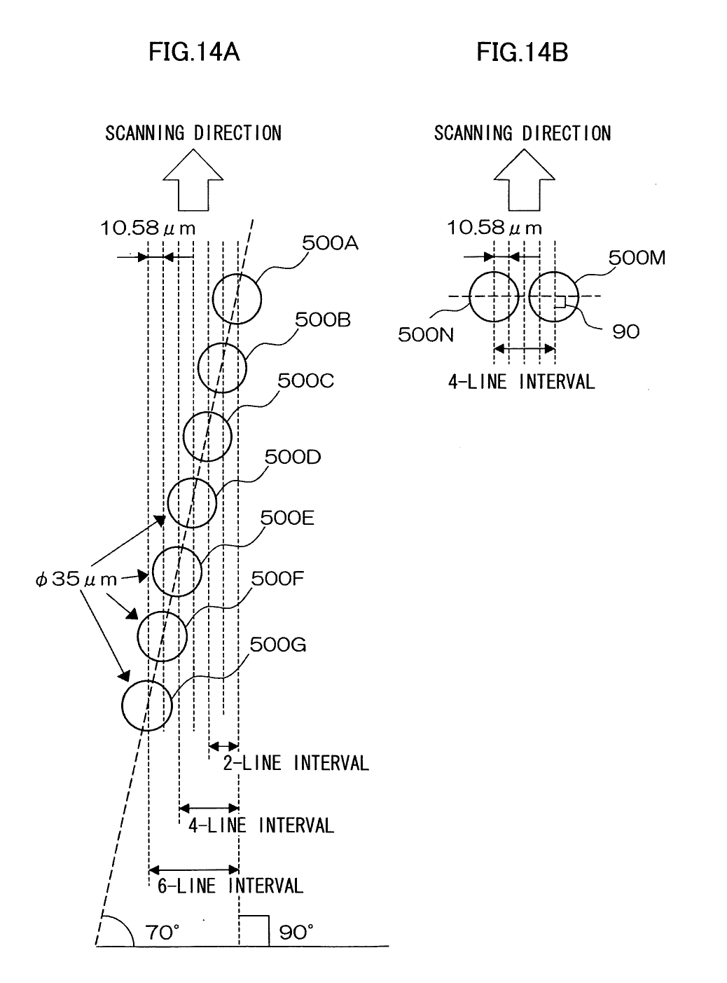

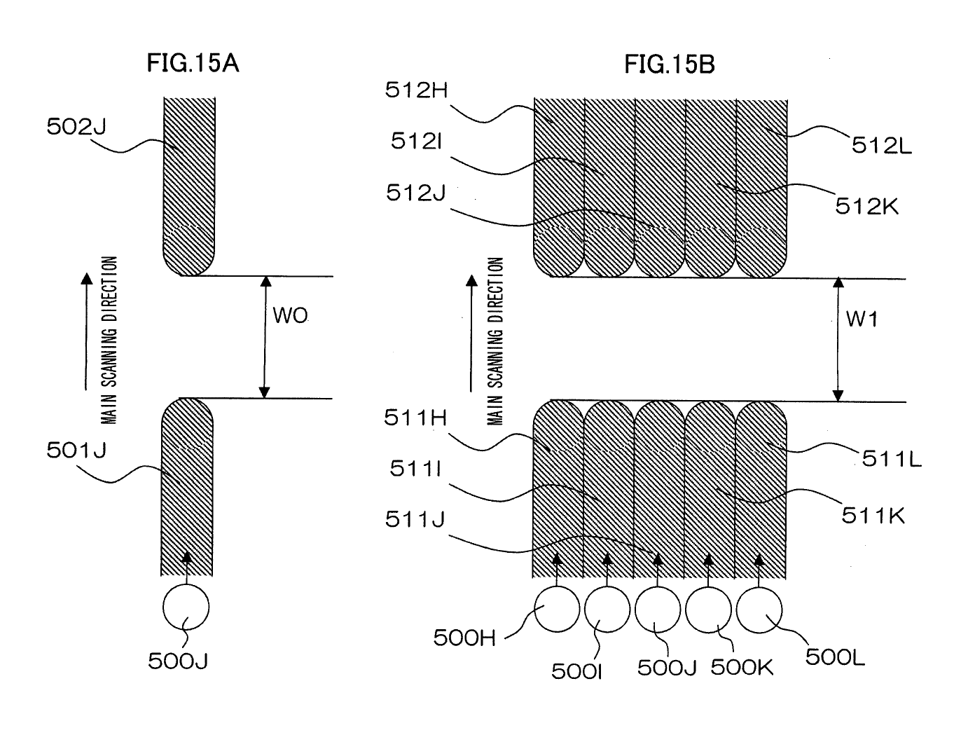

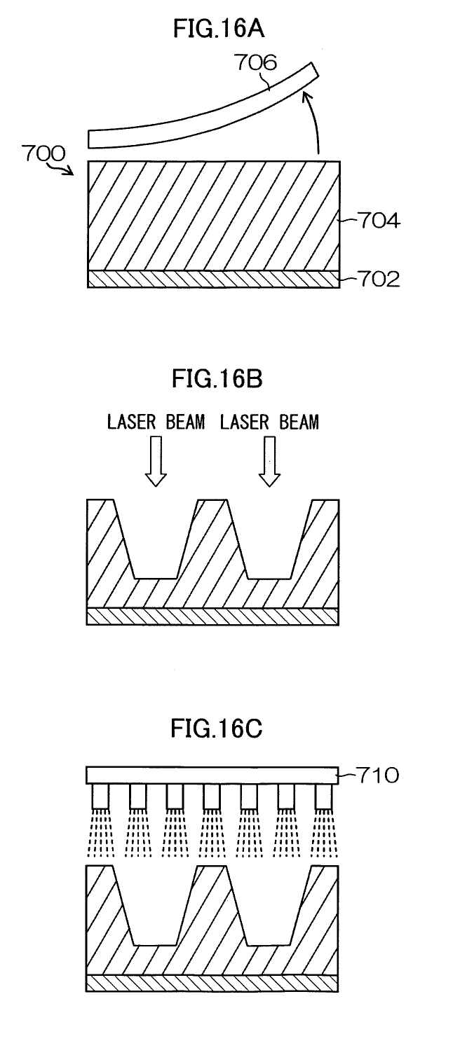

### BRIEF DESCRIPTION OF DRAWINGS

[FIG. 1] FIG. 1 shows the structure of a plate making apparatus that uses a multibeam exposure scanning apparatus according to an embodiment of the present invention.

[FIG. 2] FIG. 2 shows the structure of the optical fiber array module provided in the exposure head.

[FIG. 3] FIG. 3 is an enlarged view of the light emitting portion of the optical fiber array module.

[FIG. 4] FIG. 4 is a schematic view of the imaging optical system of the optical fiber array module.

[FIG. 5] FIG. 5 is a diagram for explaining the relationship between an example of arrangement of optical fibers and scanning lines in the optical fiber array module.

[FIG. 6] FIG. 6 is a plan view schematically showing the scanning exposure system of the plate making apparatus in this embodiment.

[FIG. 7] FIG. 7 is a block diagram showing the structure of the control system of the plate making apparatus in this embodiment.

[FIG. 8] FIG. 8 is a diagram illustrating the first exposure scanning at the same sub scanning location.

[FIG. 9] FIG. 9 is a diagram illustrating the second exposure scanning at the same sub scanning location.

[FIG. 10] FIG. 10 is a diagram illustrating the third exposure scanning at the same sub scanning location.

[FIG. 11] FIG. 11 is a diagram illustrating the fourth exposure scanning at the same sub scanning location.

[FIG. 12] FIG. 12 is a diagram illustrating the fifth exposure scanning at the same sub scanning location.

[FIG. 13] FIG. 13 is a diagram illustrating the exposure control in spiral exposure operations.

[FIG. 14A] FIG. 14A is a diagram for explaining the influence of the heat from beams on the engraving in the depth direction.

[FIG. 14B] FIG. 14B is a diagram for explaining the influence of the heat from beams on the engraving in the depth direction.

[FIG. 15A] FIG. 15A is a diagram for explaining the influence of the heat from beams on the engraving in the planar direction.

[FIG. 15B] FIG. 15B is a diagram for explaining the influence of the heat from beams on the engraving in the planar direction.

[FIG. 16A] FIG. 16A is an explanatory view outlining the process for manufacturing a flexographic plate.

[FIG. 16B] FIG. 16B is an explanatory view outlining the process for manufacturing a flexographic plate.

[FIG. 16C] FIG. 16C is an explanatory view outlining the process for manufacturing a flexographic plate.

### DESCRIPTION OF EMBODIMENTS

The following is a detailed description of embodiments of the present invention, with reference to the accompanying drawings.

### Influence of Heat from Adjacent Beams

First, the influence of the heat generated from adjacent beams when a plate is engraved through multibeam exposure is described.

FIG. 14A is a diagram showing an example case where a plurality of beams 500A through 500G with the same light intensity are arranged in a line inclined at an angle of 20 degrees with respect to the scanning direction of a plate material. In this example, the diameter of each beam is φ35 μm, and the interval between each two lines to be exposed with the respective beams is 10.58 μm. The applicant conducted experiments by engraving a plate material with the use of beams arranged in this manner, and examined the influence of the heat from the beams on the engraving in the depth direction.

First, exposure was performed at a two-line interval with the use of the two beams of the beam 500A and the beam 500C, and checked the depth of the engraving performed with the beam 500C. The result confirmed that the engraving performed with the beam 500C was about 1.5 times as deep as the engraving performed with only one beam (with only the beam 500C).

Exposure was then performed at a four-line interval with the use of the two beams of the beam 500A and the beam 500E in the same manner as above, and checked the depth of the engraving performed with the beam 500E. The result confirmed that the engraving performed with the beam 500E was about 1.2 times as deep as the engraving performed with only one beam.

Exposure was further performed at a six-line interval with the use of the two beams of the beam 500A and the beam 500G, and checked the depth of the engraving performed with the beam 500G. The result confirmed that the engraving performed with the beam 500G was about 1.1 times as deep as the engraving performed with only one beam.

In this manner, it is confirmed that, where beams are arranged in an oblique direction, and exposure is performed with a plurality of beams, the heat from the beam that has scanned earlier has influence on the depth of the engraving performed with the beam that scans next.

FIG. 14B is a diagram showing an example case where two beams 500M and 500N that are the same as the beams 500A through 500G are arranged at a four-line interval (a 42-μm interval) so as to be perpendicular to the scanning direction of the plate material. In the same manner as above, the applicant examined the influence of the heat from the beams on the engraving in the depth direction.

As a result, it is confirmed that, where exposure was performed simultaneously with the use of the two beams of the beam 500M and the beam 500N, the depth of the engraving performed with each beam was the same as the depth performed with a single beam, before the engraving becomes as deep as or deeper than 50 μm from the surface (as long as the beam power has such a value that enables engraving as deep as 50 μm from the surface).

The applicant also examined the influence of the heat from beams on the engraving in the planar direction of the plate material. FIG. 15A is a diagram showing engraving performed on a plate material through exposure with a beam 500J. FIG. 15A shows engraving areas 501J and 502J seen before and after a suspension of the exposure in a case where exposure is performed with the beam 500J while main scanning is performed on the plate material, and, after the exposure is suspended for a predetermined period of time, the exposure is resumed. FIG. 15B is a diagram showing engraving performed on a plate material through exposure with a plurality of beams 500H through 500L with the same light intensity, which are arranged in a direction perpendicular to the main scanning direction. FIG. 15B shows engraving areas 511H through 511L and 512H through 512L seen before and after a suspension of the exposure in a case where exposure is performed with the plurality of beams while main scanning is performed on the plate material, and, after the exposure is suspended for the same period of time as in the case of FIG. 15A, the exposure is resumed.

From each plate material obtained through the above exposure, the width W0 (the distance between the area 501J and the area 502J) and the width W1 (the distance between the area 511J and the area 512J) of the respective areas in which the exposure was suspended (the areas that were not engraved), and the depths (50 μm being the maximum in the evaluation) of the engravings in the engraving areas 501J, 502J, 511J, and 512J were evaluated. The results of the evaluation show that there are no differences in width and depth between the two cases.

As described above, the applicant confirmed that beams emitted simultaneously in a direction perpendicular to the scanning direction of a plate material are not affected in both the depth direction and planar direction of the plate material by the heat generated from one another, since the exposure with adjacent beams ends before the heat generated due to the exposure is transmitted to the adjacent beams. From this fact, the applicant discovered that the same engraving performance as the engraving performance achieved in the case of exposure with a single beam can be achieved with the use of beams that are arranged in a direction perpendicular to the scanning direction of the plate material.

### Example Structure of a Multibeam Exposure Scanning Apparatus

FIG. 1 shows the structure of a plate making apparatus to which a multibeam exposure scanning apparatus according to an embodiment of the present invention. The plate making apparatus 11 shown in the figure has a sheet-like plate material F (equivalent to the “recording medium”) fixed onto the outer circumferential face of a drum 50 having a cylindrical shape. The drum 50 is rotated in the direction of the arrow R of FIG. 1 (the main scanning direction), and a plurality of laser beams corresponding to the image data of the image to be engraved (recorded) on the plate material F are emitted onto the plate material F from an exposure head 30 of a laser recording apparatus 10, and the exposure head 30 scans in a sub scanning direction (the direction of the arrow S of FIG. 1) perpendicular to the main scanning direction at predetermined pitch. In this manner, a two-dimensional image is engraved (recorded) on the surface of the plate material F at high speed. Here, an example case where a flexographic printing rubber or resin plate is used is described.

The laser recording apparatus 10 used for the plate making apparatus 11 in this embodiment includes a light source unit 20 that generates a plurality of laser beams, the exposure head 30 that emits the plurality of laser beams generated from the light source unit 20 onto the plate material F, and an exposure head moving unit 40 that moves the exposure head 30 in the sub scanning direction.

The light source unit 20 includes sixteen semiconductor lasers 21A, sixteen semiconductor lasers 21B, sixteen semiconductor lasers 21C, and sixteen semiconductor lasers 21D. The lights from the respective semiconductor lasers 21A through 21D are transmitted to an optical fiber array module 300 of the exposure head 30 through sixteen optical fibers 22A, sixteen optical fibers 22B, sixteen optical fibers 22C, and sixteen optical fibers 22D, respectively, and further through sixteen optical fibers 70A, sixteen optical fibers 70B, sixteen optical fibers 70C, and sixteen optical fibers 70D, respectively.

In this embodiment, broad area semiconductor lasers (wavelength: 915 nm) are used as the semiconductor lasers 21A through 21D, and the semiconductor lasers 21A through 21D are arranged on light source substrates 24A, 24B, 24C, and 24D.

Each of the semiconductor lasers 21A through 21D is coupled to one end of each corresponding one of optical fibers 22A through 22D, and the other end of each of the optical fibers 22A through 22D is connected to the adapter of each corresponding one of sixteen FC optical connectors 25A, sixteen FC optical connectors 25B, sixteen FC optical connectors 25C, and sixteen FC optical connectors 25D.

Each of adapter substrates 23A, 23B, 23C, and 23D that support the FC optical connectors 25A through 25D is perpendicularly attached to one end of each corresponding one of the light source substrates 24A, 24B, 24C, and 24D. Each of LD driver substrates 27A, 27B, 27C, and 27D on which LD driver circuits (not shown in FIG. 1, but designated by reference numeral 26 in FIG. 7) for driving the semiconductor lasers 21A through 21D are mounted is attached to the other end of each corresponding one of the light source substrates 24A through 24D. Each of the semiconductor lasers 21A through 21D is connected to each corresponding one of the LD driver circuits via each corresponding one of wiring members 29A, 29B, 29C, and 29D. The semiconductor lasers 21A through 21D are driven and controlled independently of one another.

In this embodiment, multimode optical fibers having relatively large core diameters are used as the optical fibers 70A through 70D, so that the laser beams become high-power beams. Specifically, optical fibers of 105 μm in core diameter are used in this embodiment. Also, semiconductor lasers of about 10 W in maximum power are used as the semiconductor lasers 21A through 21D. Specifically, those available from JDS Uniphase Corporation, which are 105 μm in core diameter and 10 W in power (6398-L4), can be used, for example.

Meanwhile, the exposure head 30 has the optical fiber array module 300 that captures the respective laser beams emitted from the plurality of semiconductor lasers 21A through 21D, and collectively emits the laser beams. The light emitting portion (not shown in FIG. 1, but designated by reference numeral 280 in FIG. 2) of the optical fiber array module 300 includes levels of four vertically arranged rows: one of the rows is formed by the emitting ends of the sixteen optical fibers 70A led from the semiconductor lasers 21A, another one of the rows is formed by the emitting ends of the sixteen optical fibers 70B led from the semiconductor lasers 21B, yet another one of the rows is formed by the emitting ends of the sixteen optical fibers 70C led from the semiconductor lasers 21C, and the remaining one of the rows is formed by the emitting ends of the sixteen optical fibers 70D led from the semiconductor lasers 21D (see FIG. 3).

In the exposure head 30, a collimator lens 32, an opening member 33, and an imaging lens 34 are arranged in this order from the light emitting side of the optical fiber array module 300. The collimator lens 32 and the imaging lens 34 form an imaging optical system. The opening member 33 is placed so that its opening is located in the position of the far field when seen from the side of the optical fiber array module 300. With this arrangement, all the laser beams emitted from the optical fiber array module 300 can be subjected equally to optical limitation.

The exposure head moving unit 40 includes a ball screw 41 and two rails 42 that have their longitudinal directions extending in the sub scanning direction. When a sub scanning motor (not shown in FIG. 1, but designated by reference numeral 43 in FIG. 7) that rotates and drives the ball screw 41 is activated, the exposure head 30 placed on the ball screw 41 can be guided along the rails 42 and be moved in the sub scanning direction. Also, when a main scanning motor (not shown in FIG. 1, but designated by reference numeral 51 in FIG. 7) is activated, the drum 50 can be rotated and driven in the direction of the arrow R of FIG. 1. In this manner, main scanning is performed.

FIG. 2 shows the structure of the optical fiber array module 300. FIG. 3 is an enlarged view of the optical emitting portion 280 (seen from the direction of the arrow A of FIG. 2). The light emitting portion 280 of the optical fiber array module 300 includes optical fiber array units 300A, 300B, 300C, and 300D that are put together as a four-level structure in the vertical direction. On each level, the sixteen optical fibers 70A, 70B, 70C, or 70D having the same core diameter of 105 μm are aligned.

The optical fiber array unit 300A includes an optical fiber end group 301A formed by optical fiber end portions 71A linearly arranged at intervals of L1 (=127 μm) in a predetermined direction. Likewise, the optical fiber array units 300B through 300D respectively include optical fiber end portions 301B through 301D formed by optical fiber end portions 71B, 71C, and 71D linearly arranged at the intervals of L1 (=127 μm) in the predetermined direction. The respective optical fiber array units 300A through 300D are arranged in parallel to one another and to the predetermined direction.

In the optical fiber array module 300, the optical fiber array units 300A through 300D are arranged so that the respective optical fiber end portions 71A through 71D are misaligned from one another by L2 (=31.75 μm) in a direction perpendicular to the predetermined direction. That is, the optical fiber end portions 71A and 71B are arranged at the intervals of L1, and the center of each optical fiber end portion 71B is positioned so as to be misaligned from the center of each corresponding optical fiber end portion 71A by L2 in the direction (toward the left in FIG. 3) perpendicular to the predetermined direction. Likewise, the center of each optical fiber end portion 71C is misaligned from the center of each corresponding optical fiber end portion 71B by L2, and the center of each optical fiber end portion 71D is misaligned from the center of each corresponding optical fiber end portion 71C by L2.

Accordingly, when the respective optical fiber end portions 71A through 71D are projected in the direction perpendicular to the predetermined direction, all the optical fiber end portions are arranged at the intervals of L2. The laser beams of those optical fiber end portions (16×4) are emitted from the light emitting portion 280 of the optical fiber array module 300.

FIG. 4 is a schematic view of the imaging system of the optical fiber array module 300. As shown in FIG. 4, the imaging unit formed by the collimator lens 32 and the imaging lens 34 causes the light emitting portion 280 of the optical fiber array module 300 to form an image in the vicinity of the exposure face (the surface) FA of the plate material F at a predetermined imaging magnification. In this embodiment, the imaging magnification is set at ⅓. Accordingly, the spot diameter of the laser beam LA emitted from the optical fiber end portion 71A through 71D of 105 μm in core diameter is φ35 μm. Although the imaging magnification is fixed in this embodiment, an exposure lens that can vary the imaging magnification may be used.

In the exposure head 30 having such an imaging system, the arrangement direction of the linearly-arranged optical fiber end portions 71A (71B, 71C, or 71D) is the same as the sub scanning direction. Accordingly, as shown in FIG. 5, the intervals of P2 between the scanning lines (the main scanning lines) K to be exposed with the laser beams 100A through 100D emitted from the respective optical fiber end portions 71A through 71D can be set at 10.58 μm (equivalent to a resolution of 2400 dpi in the sub scanning direction).

With the use of the exposure head 30 having the above described structure, a 64-line range (equivalent to one swath) can be simultaneously scanned and exposed by the four-level optical fiber end portion groups 301A through 301D of the optical fiber array module 300.

The optical fiber array module 300 of this embodiment has sixteen optical fiber end portions in the sub scanning direction, and four-level sixty-four optical fiber end portions in total in the main scanning direction. However, the number of optical fiber end portions and the number of levels may be arbitrarily determined in accordance with the size of the exposure head 30, the core diameter of each optical fiber, and the like.

FIG. 6 is a plan view schematically showing the scanning exposure system in the plate making apparatus 11 shown in FIG. 1. The exposure head 30 includes a focus point changing mechanism 60 and a sub-scanning-direction intermittent feeding mechanism 90.

The focus point changing mechanism 60 includes a motor 61 and a ball screw 62 that move the exposure head 30 toward and away from the surface of the drum 50. By controlling the motor 61, the focus point changing mechanism 60 can move the point of focus about 339 μm in about 0.1 second. The intermittent feeding mechanism 90 forms the exposure head moving unit 40 described with reference to FIG. 1. The intermittent feeding mechanism 90 includes a ball screw 41 and a sub scanning motor 43 that rotates the ball screw 41, as shown in FIG. 6. The exposure head 30 is fixed onto a stage 44 on the ball screw 41. By controlling the sub scanning motor 43, the exposure head 30 can intermittently feed the exposure head 30 for one swath (10.58 μm×64 ch=677.3 μm in the case of 2400 dpi) in about 0.1 second in the direction of axis 52 of the drum 50.

In FIG. 6, reference numerals 46 and 47 designate bearings that rotatably support the ball screw 41. Reference numeral 55 designates a chuck member that chucks the plate material F on the drum 50. The chuck member 55 is located in a non-recording area in which exposure (recording) by the exposure head 30 is not to be performed. While the drum 50 is being rotated, 64-channel laser beams are emitted from the exposure head 30 onto the plate material F on the rotating drum 50. In this manner, an exposure range 92 of sixty-four channels (equivalent to one swath) is exposed without any space between the channels, and 1-swath wide engraving (image recording) is performed on the surface of the plate material F. When the chuck member 55 passes in front of the exposure head 30 (in the non-recording area of the plate material F) as the drum 50 rotates, intermittent feeding is performed in the sub scanning direction, and the next one swath is then exposed. The exposure scanning involving the intermittent feeding in the sub scanning direction is repeated to form a desired image on the entire surface of the plate material F.

Although the sheet-like plate material F (the recording medium) is used in this embodiment, it is also possible to use a cylindrical recording medium (of a sleeve type).

### Structure of the Control System

FIG. 7 is a block diagram showing the structure of the control system of the plate making apparatus 11. As shown in FIG. 7, the plate making apparatus 11 includes the LD driver circuits 26 that drive the respective semiconductor lasers 21A through 21D in accordance with two-dimensional image data to be engraved, the main scanning motor 51 that rotates the drum 50, a main scanning motor driver circuit 81 that drives the main scanning motor 51, a sub scanning motor driver circuit 82 that drives the sub scanning motor 43, and a control circuit 80. The control circuit 80 controls the LD driver circuits 26, and the respective motor driver circuits 81 and 82.

The image data representing the image to be engraved (recorded) on the plate material F is supplied to the control circuit 80. Based on the image data, the control circuit 80 controls the main scanning motor 51 and the sub scanning motor 43, and also controls the powers of the respective semiconductor lasers 21A through 21D (or the powers of laser beams) independently of one another.

### First Embodiment

Next, an exposure scanning process to be performed when a printing plate is manufactured by a multibeam exposure system is described. In this embodiment, the exposure head 30 having the optical fiber array module 300 shown in FIG. 3 is used, and exposure scanning is performed on respective sub scanning locations five times each (with the exposure head 30 not being moved). Here, the area peripheral to the flat face (the printing face) to be maintained on the surface of the plate material F is set as a precise engraving area, and the area peripheral to the peripheral area is set as a rough engraving area. The rough engraving area is subjected to collective exposure scanning performed with the use of all beams, and the precise engraving area is subjected to exposure scanning performed by each of the beam rows arranged in the direction perpendicular to the scanning direction.

FIGS. 8 through 12 respectively illustrate the first through fifth exposure scannings at the same sub scanning location. The respective portions (b) of FIGS. 8 through 12 illustrate the exposure control performed on the laser beams 100A through 100D emitted from the respective optical fiber end portions 71A through 71D. Portions (a) each show a cross-section of the plate material F on which engraving has been performed through the exposure control illustrated in the portion (b). For ease of explanation, the number of laser beams shown here is smaller than the actual number, and the laser beams 100A through 100D perform the main scanning on the plate material F relatively upward in the drawings.

In FIGS. 9 through 11, strictly speaking, the respective cross-sections of the plate material F have various engraving depths, depending on which scanning line of the laser beams 100A through 100D is shown. However, the respective sections shown in portions (a) have average engraving depths of the respective scanning lines.

First, the first exposure scanning at the sub scanning location is performed on the rough engraving area with the use of all the laser beams 100A through 100D, as shown in (b) of FIG. 8. As already described with reference to FIGS. 14A and 14B, when exposure is performed with a plurality of beams that are arranged in an oblique direction, the depth of the engraving performed by the next scanning beam becomes larger by virtue of the heat from the previous scanning beam. Accordingly, by performing engraving in this manner, heat introduction from adjacent beams is facilitated, and the engraving efficiency can be improved. In this case, the engraving efficiency becomes M times higher than that in a case where engraving is performed only with a single beam.

In the rough engraving area, the powers of the laser beams 100A through 100D are controlled to become linearly lower toward the precise engraving area. In this manner, unnecessary engraving due to heat introduction into the precise engraving area is prevented.

In the first exposure scanning as a rough engraving process, exposure is performed only on the rough engraving area, and exposure is not performed on the precise engraving area.

As a result, the surface of the plate material F is engraved as shown in the portion (a) of FIG. 8. That is, only the rough engraving area is engraved, and the engraving depth in the rough engraving area becomes smaller toward the precise engraving area. As the rough engraving area has such a cross-section, the surface area of the rough engraving area can be increased. Accordingly, heat introduction into the precise engraving area in the later exposure scannings can be reduced.

In the second exposure scanning, as shown in the portion (b) of FIG. 9, exposure scanning is performed on the rough engraving area with the use of all the laser beams 100A through 100D, and the heat introduction from adjacent beams is facilitated to improve the engraving efficiency. Also, the powers of the laser beams 100A through 100D are controlled to linearly become lower toward the precise engraving area, as in the first exposure scanning.

Further, exposure scanning is performed on the precise engraving area only with the use of the laser beams 101D that are emitted from the optical fiber end portions 71D arranged on the lowest level among the laser beams 100A through 100D emitted from the respective optical fiber end portions 71A through 71D arranged on the four levels in the sub scanning direction. As described with reference to FIG. 14, laser beams that are simultaneously emitted in a direction (the sub scanning direction) perpendicular to the main scanning direction are not interfered by the heat from one another. Accordingly, by performing control in the above manner, only the scanning lines exposed with the laser beams 101D in the precise engraving area can be engraved with high precision.

In the precise engraving area engraved in this manner, there is no interference by the heat from adjacent laser beams. Accordingly, the engraving efficiency in the precise engraving area is 1/M times as high as the engraving efficiency in the rough engraving area on which exposure is simultaneously performed with the plurality of beams arranged in the oblique direction. Therefore, the powers of the laser beams 100D emitted to the precise engraving area should preferably be M times higher than the powers emitted to the rough engraving area. That is, when exposure is simultaneously performed only with a plurality of beams arranged in the sub scanning direction, the powers of the laser beams are increased by the amount equivalent to the increase in engraving efficiency achieved by simultaneously performing exposure with a plurality of beams arranged in the oblique direction. In this manner, the engraving depth and width achieved by a single main scanning operation can be made the same in both cases, and the continuity between the precise engraving area and the rough engraving area can be maintained.

Also, in the precise engraving area, the powers of the laser beams 100D are controlled to linearly become lower toward the printing face. Through this control, unnecessary engraving due to heat introduction into the printing face is prevented.

As a result, the surface of the plate material F is engraved as shown in the portion (a) of FIG. 9. That is, the rough engraving area is engraved deeper than that in the cross-section seen after the first exposure scanning, and only the area scanned with the laser beams 101D is engraved in the precise engraving area. Also, in the precise engraving area, the engraving depth becomes smaller toward the printing face.

In the third exposure scanning, as shown in the portion (b) of FIG. 10, exposure scanning is performed on the rough engraving area with the laser beams 100A through 100D as in the second exposure scanning. Further, exposure scanning is performed on the precise engraving area only with the use of the laser beams 101C emitted from the optical fiber end portions 71C arranged on the third level from the top among the laser beams 100A through 100D emitted from the respective optical fiber end portions 71A through 71D arranged on the four levels in the sub scanning direction. As in the second exposure scanning, the powers of the laser beams 100C emitted to the precise engraving area should preferably be M times higher than the powers obtained when the laser beams 100C are emitted to the rough engraving area. Also, the powers of the laser beams 100C are controlled to linearly become lower toward the printing face. Accordingly, in the third exposure scanning, efficient engraving can be performed on the rough engraving area, and only the scanning lines exposed with the laser beams 101C can be engraved with high precision in the precise engraving area.

As a result, the surface of the plate material F is engraved as shown in the portion (a) of FIG. 10. That is, the rough engraving area is engraved even deeper than that in the cross-section seen after the second exposure scanning, and only the area scanned with the laser beams 101C is engraved in the precise engraving area. As can be seen from the average of the cross-sections at the respective scanning line locations, the precise engraving area is engraved even deeper than that in the cross-section seen after the second exposure scanning.

Likewise, the fourth exposure scanning is performed on the rough engraving area with the laser beams 100A through 100D, and is performed on the precise engraving area only with the use of the laser beams 101B arranged on the second level from the top, as shown in the portion (b) of FIG. 11. Also, the fifth exposure scanning is performed on the rough engraving area with the laser beams 100A through 100D, and is performed on the precise engraving area only with the use of the laser beams 101A arranged on the highest level, as shown in the portion (b) of FIG. 12.

Accordingly, through the fourth and fifth exposure scannings, the rough engraving area can be engraved with high efficiency, and only the exposed scanning lines can be engraved with high precision in the precise engraving area.

As a result, the surface of the plate material F is engraved as shown in the portion (a) of FIG. 11 through the fourth exposure scanning, and is engraved as shown in the portion (a) of FIG. 12 through the fifth exposure scanning. As shown in the portion (a) of FIG. 12, engraving is performed so that the precise engraving area has a sharp edge with respect to the printing face in the end.

After the engraving of one swath is completed through the five rotations of the drum 50, the exposure head 30 is intermittently fed in the sub scanning direction (toward the left in FIG. 6) when the chuck member 55 as the non-recording area passes in front of the exposure head 30, and the exposure head 30 is moved to a location where the engraving of the next one swath is to be performed. At that location, the exposure scanning illustrated in FIGS. 8 through 12 is performed in the same manner as above. Thereafter, the above described processes are repeated to expose the entire surface on the plate material F.

As described above, the levels that emit beams are sequentially switched for each main scanning operation performed for the area peripheral to the surface area to be maintained as a convex flat portion in the end. Heat introduction from adjacent beams is restrained by allowing only the emitting outlet row on one level to emit beams. In this manner, precise engraving is enabled, and the tapered portion can be appropriately shaped. As for the area peripheral to the peripheral area, beams are emitted to the area simultaneously from the rows of emitting outlets on all the levels. In this manner, heat introduction from adjacent beams is facilitated, and the engraving efficiency can be improved accordingly.

The order of beam rows used at the time of exposure scanning is not limited to the above described order. For example, exposure scanning may be performed with the laser beams 100A, 100B, 100C, and 100D in this order, or may be performed in any other order.

Also, the first exposure scanning as the rough engraving process may be omitted, and the engraving of each one swath may be completed through four rotations of the drum 50.

### Second Embodiment

In the first embodiment, the levels that emit beams are switched for each main scanning operation, and only the emitting outlet row on one level is allowed to emit beams. In the second embodiment, however, control is performed to perform exposure on the precise engraving area only with the laser beams on a predetermined one level.

To perform such exposure, sub scanning feeding to be performed by exposing and scanning only one line of each level of beam rows is combined with the intermittent feeding of the first embodiment, and sub scanning feeding is then performed.

In this embodiment, an exposure method is described as an example, and, by the method, intermittent feeding is combined with spiral exposure to be performed by scanning the surface of the plate material F in a spiral fashion with the exposure head 30 moving in the sub scanning direction at a constant velocity while the drum 50 is rotating.

FIG. 13 illustrates the exposure control to be performed on the laser beams 100A through 100D emitted from the respective optical fiber end portions 71A through 71D in a case where an exposure method that combines spiral exposure and intermittent feeding with the use of the exposure head 30 including the optical fiber array module 300 shown in FIG. 3 is employed. For ease of explanation, the number of laser beams shown in FIG. 13 is smaller than the actual number.

First, in the first exposure scanning, exposure scanning is performed on the rough engraving area with the use of all the laser beams 100A through 100D, as shown in the portion (a) of FIG. 13. In this manner, heat introduction from adjacent beams is facilitated, and the engraving efficiency is improved. As in the first embodiment, the powers of the laser beams 100A through 100D in the rough engraving area should preferably be controlled to linearly become lower toward the precise engraving area.

Further, exposure scanning is performed on the precise engraving area only with the use of the laser beams emitted from predetermined optical fiber end portions among the laser beams 100A through 100D emitted from the respective optical fiber end portions 71A through 71D arranged on the four levels in the direction perpendicular to the main scanning direction. In the example illustrated in FIG. 13, only the laser beams 101D emitted from the optical fiber end portions 71D arranged on the lowest level are used. Through this control, only the scanning lines exposed with the laser beams 101D can be engraved with high precision in the precise engraving area.

After that, the respective beams scan in a spiral fashion, as the exposure head 30 is moving in the sub scanning direction at a predetermined velocity. When the main scanning point reaches the location at which the engraving has been performed as shown in the portion (a) of FIG. 13, the exposure head 30 has moved by one line in the sub scanning direction (toward the right in FIG. 13). That is, the exposure head 30 is controlled to move by one main scanning line (P2=10.58 μm in FIG. 5) in the sub scanning direction at a constant velocity, while the drum 50 turns 360 degrees.

Therefore, in the second exposure scanning, exposure scanning is performed on the rough engraving area with the use of all the laser beams 100A through 100D, as shown in the portion (b) of FIG. 13. Further, exposure scanning is performed on the precise engraving area only with the use of the laser beams 101D emitted from the predetermined optical fiber end portions 71D, as in the previous exposure scanning. Accordingly, efficient engraving can be performed on the rough engraving area, and only the scanning lines exposed with the laser beams 101D can be engraved with high precision in the precise engraving area.

In the third and fourth exposure scannings, scanning is also performed in a spiral fashion, and exposure scanning is performed on the rough engraving area with the use of all the laser beams 100A through 100D. Exposure scanning is performed on the precise engraving area only with the use of the laser beams 101D emitted from the predetermined optical fiber end portions 71D (see the portions (c) and (d) of FIG. 13).

After that, intermittent feeding in the sub scanning direction is performed for sixty lines (the total number of channels (=64) minus the number of times spiral feeding is performed (=4)), and spiral exposure is again performed only for four lines. The above operation is repeatedly performed to expose and scan the entire surface of the plate material F.

As described above, beams are emitted only from the emitting outlet row of a predetermined one level onto the area peripheral to the surface portion to be maintained as a concave flat portion in the end. In this manner, heat introduction from adjacent beams is restrained, and precise engraving is performed. Also, the tapered portion is appropriately shaped through the engraving. Further, beams are emitted simultaneously from the emitting outlet rows of all the levels onto the area peripheral to the area peripheral to the surface portion. In this manner, heat introduction from adjacent beams is facilitated, and the engraving efficiency can be improved accordingly.

Further, according to the exposure method that combines spiral exposure and intermittent feeding, even when there is a problem with the operation of the light source or fibers of the laser beams of a level used for the precise engraving area among the laser beams arranged on several levels in the sub scanning direction, exposure of the precise engraving area can be continued by setting the laser beams of another level as the laser beams for the precise engraving area. Although the engraving efficiency in the rough engraving area becomes somewhat lower, engraving can be advantageously continued without a reduction of productivity.

Although the optical fiber ends forming the respective levels can be formed at regular intervals with high precision, lateral misalignment might be caused in the respective levels (positional misalignment of the optical fiber array units 300A, 300B, 300C, and 300D in the lateral direction in the example illustrated in FIG. 3) during the manufacturing process or the like. In such a case, seam-like surface irregularities are formed on the engraved plate material F. According to the exposure method of this embodiment that combines spiral exposure and intermittent feeding, however, the intervals between the respective lines in the precise engraving area are determined by the sub scanning accuracy of the spiral exposure. Accordingly, small lateral misalignment can be allowed, and increases of the costs for the exposure head 30 can be advantageously restrained.

The sub scan feeding to be performed by exposing and scanning one line of each level of the beam rows is not limited to the above described spiral exposure, but one-line sub scanning may be performed for one main scanning operation.

That is, in the first exposure, exposure scanning is performed on the rough engraving area with the use of all the laser beams 100A through 100D, and exposure scanning is performed on the precise engraving area only with the use of the laser beams 101D, as shown in the portion (a) of FIG. 13.

After the first main scanning at the location shown in the portion (a) of FIG. 13 is completed, one-line sub scanning feeding is performed onto the location shown in the portion (b) of FIG. 13, and the second exposure is performed. In the second exposure, exposure is also performed on the rough engraving area with the use of all the laser beams 100A through 100D, and exposure is performed on the precise engraving area only with the use of the laser beams 101D.

Likewise, after the main scanning at the location shown in the portion (b) of FIG. 13 is completed, one-line sub scanning feeding is performed, and the third exposure is performed as shown in the portion (c) of FIG. 13. Further, after the main scanning is completed, one-line sub scanning feeding is performed, and the fourth exposure is performed as shown in the portion (d) of FIG. 13.

After that, intermittent feeding is performed for sixty lines (the total number of channels (=64) minus the number of times one-line feeding is performed (=4)), and exposure is again performed for four lines while sub scanning is performed line by line. The above operation is repeatedly performed to expose and scan the entire surface of the plate material F.

By performing the sub scanning in the above manner, exposure can be performed on the precise engraving area only with the laser beams of a predetermined level.

In the first and second embodiments, a plurality of laser beams are emitted onto a recording medium attached to the outer circumferential face of the cylindrical drum 50. However, a plurality of laser beams may be emitted onto a recording medium attached to the inner circumferential face of the drum. Alternatively, the drum may not be rotated, but the head may be rotated.

In embodiments other than the spiral exposure, a plurality of laser beams may be emitted onto a recording medium having a flat surface.

### Process for Manufacturing Flexographic Plate

Next, an exposure and scanning process to be performed when a printing plate is manufactured by a multibeam exposure system is described.

FIGS. 16A to 16C schematically show the plate making process. A material plate 700 used for plate making by laser engraving has an engraving layer 704 (a rubber layer or a resin layer) on a substrate 702, and also has a protection cover film 706 bonded onto the engraving layer 704. In a plate making process, the engraving layer 704 is exposed on the surface by detaching the cover film 706 from the engraving layer 704, as shown in FIG. 16A. Laser beams are then emitted onto the engraving layer 704, so that the engraving layer 704 is partially removed, and a desired three-dimensional form is shaped (see FIG. 16B). The specific laser engraving method has been described with reference to FIGS. 1 through 15B. The dust generated during the laser engraving is sucked and collected by a suction device (not shown).

After the engraving process is completed, water cleaning with a cleaning device 710 is performed (a cleaning process), as shown in FIG. 16C. A drying process (not shown) is then performed to complete a flexographic plate.

A plate making method by which laser engraving is performed directly on a plate as above is called a direct engraving method. A plate making apparatus that uses the multibeam exposure scanning apparatus according to this embodiment can be provided at a lower price than a laser engraving machine that uses a CO₂ laser. Also, with the use of multi beams, the processing speed can be made higher, and the printing plate productivity can be improved.

### Other Applications

The present invention can be applied not only to the manufacture of flexographic plates, but also to the manufacture of other convex printing plates or concave printing plates. Further, the present invention can be applied not only to the manufacture of printing plates, but also to other graphic recording apparatuses and engraving apparatuses for various kinds of usage.

### REFERENCE SIGNS LIST

10 laser recording apparatus

11 plate making apparatus

20 light source unit

21A, 21B, 21C, 21D semiconductor lasers

22A, 22B, 22C, 22D, 70A, 70B, 70C, 70D optical fibers

30 exposure head

40 exposure head moving unit

50 drum

80 control circuit

300 optical fiber array module

F plate material

K scanning lines (main scanning lines)

1-13. (canceled)

14. A multibeam exposure scanning method for engraving a surface of a recording medium by emitting a plurality of beams simultaneously from an exposure head to the recording medium, the exposure head having N levels (N being an integer equal to or greater than 2) of emitting outlet rows each having emitting outlets arranged at intervals of P in a sub scanning direction, the N levels being arranged at regular intervals in a main scanning direction perpendicular to the sub scanning direction, the respective levels being arranged so that respective projected emitting outlets are located at intervals of P/N when the respective emitting outlets are projected in the main scanning direction:
the multibeam exposure scanning method comprising the steps of:
scanning the recording medium in the main scanning direction N times with the exposure head; and
emitting beams to a first area from only the emitting outlet row of one level while sequentially switching the levels to emit beams for each main scanning operation, where the surface of the recording medium is divided into a target flat area to be maintained without engraving, the first area to be engraved with precision, and a second area that is an area other than the target flat area and the first area.

15. The multibeam exposure scanning method according to claim 14, further comprising:
emitting beams to the second area simultaneously from the emitting outlet rows of all the levels.

16. The multibeam exposure scanning method according to claim 14, wherein the first area is an area peripheral to the target flat area to be maintained without engraving.

17. The multibeam exposure scanning method according to claim 14, wherein the second area is an area peripheral to the first area.

18. A multibeam exposure scanning apparatus that emits a plurality of beams simultaneously from an exposure head to a recording medium, and engraves a surface of the recording medium,
the multibeam exposure scanning apparatus comprising:
the exposure head that has N levels (N being an integer equal to or greater than 2) of emitting outlet rows each having emitting outlets arranged at intervals of P in a sub scanning direction, the N levels being arranged at regular intervals in a main scanning direction perpendicular to the sub scanning direction, the respective levels being arranged so that respective projected emitting outlets are located at intervals of P/N when the respective emitting outlets are projected in the main scanning direction;
a main scanning unit that causes the exposure head to scan the recording medium relatively in the main scanning direction;
a sub scanning unit that causes the exposure head to scan the recording medium relatively in the sub scanning direction;
a scan control unit that causes a sub scanning operation to be performed once every time a main scanning operation is repeated on the recording medium at least N times; and
an exposure control unit that causes only the emitting outlet row of one level to emit beams to a first area while sequentially switching the levels to emit beams for each main scanning operation, and causes the emitting outlet rows of all the levels to emit beams simultaneously to a second area, where the surface of the recording medium is divided into a target flat area to be maintained without engraving, the first area to be engraved with precision, and the second area that is an area other than the target flat area and the first area.

19. The multibeam exposure scanning apparatus according to claim 18, wherein the scan control unit causes a sub scanning operation to be performed once every time a main scanning operation is repeated on the recording medium (N+1) times, and in a first-time main scanning operation, the exposure control unit does not cause the emitting outlet rows to emit beams to the first area, and causes the emitting outlet rows of all the levels to emit beams simultaneously to the second area.

20. A multibeam exposure scanning apparatus that emits a plurality of beams simultaneously from an exposure head (30) to a recording medium, and engraves a surface of the recording medium,
the multibeam exposure scanning apparatus comprising:
an exposure unit that includes an imaging lens and the exposure head that is capable of emitting N levels (N being an integer equal to or greater than 2) of rows of beams that are emitted onto the recording medium at intervals of P in a sub scanning direction, the N levels being arranged at regular intervals in a main scanning direction perpendicular to the sub scanning direction, the exposure unit being capable of emitting beams so that main scanning lines extended in the main scanning direction from locations of the respective emitted beams are located at intervals of P/N;
a main scanning unit that causes the exposure unit to scan the recording medium relatively in the main scanning direction;
a sub scanning unit that causes the exposure unit to scan the recording medium relatively in the sub scanning direction;
a scan control unit that causes a sub scanning operation to be performed only for one main scanning line every time a main scanning operation is performed on the recording medium; and
an exposure control unit that causes only an emitting outlet row of a predetermined level to emit beams to a first area, and causes emitting outlet rows of all the levels to emit beams simultaneously to a second area, where the surface of the recording medium is divided into a target flat area to be maintained without engraving, the first area to be engraved with precision, and the second area that is an area other than the target flat area and the first area.

21. The multibeam exposure scanning apparatus according to claim 20, wherein, when the number of beams emitted onto the recording medium at the intervals of P in the sub scanning direction is T, the scan control unit causes sub scanning operations to be performed for (T×N−N) main scanning lines after N main scanning operations.

22. A multibeam exposure scanning apparatus that emits a plurality of beams simultaneously from an exposure head to a recording medium, and engraves a surface of the recording medium,
the multibeam exposure scanning apparatus comprising:
an exposure unit that includes an imaging lens and the exposure head that is capable of emitting N levels (N being an integer equal to or greater than 2) of rows of beams that are emitted onto the recording medium at intervals of P in a sub scanning direction, the N levels being arranged at regular intervals in a main scanning direction perpendicular to the sub scanning direction, the exposure unit being capable of emitting beams so that main scanning lines extended in the main scanning direction from locations of the respective emitted beams are located at intervals of P/N;
a cylindrical drum that holds the recording medium on an outer face or an inner face of the drum;
a main scanning unit that causes the exposure unit to scan the recording medium relatively in the main scanning direction by rotating the exposure unit or the drum;
a sub scanning unit that causes the exposure unit to scan the recording medium relatively in the sub scanning direction;
a scan control unit that causes sub scanning operations to be performed at regular velocity for N main scanning lines while rotating the exposure unit or the drum N times; and
an exposure control unit that causes only an emitting outlet row of a predetermined level to emit beams to a first area, and causes emitting outlet rows of all the levels to emit beams simultaneously to a second area, where the surface of the recording medium is divided into a target flat area to be maintained without engraving, the first area to be engraved with precision, and the second area that is an area other than the target flat area and the first area.

23. The multibeam exposure scanning apparatus according to claim 22, wherein, when the number of beams emitted onto the recording medium at the intervals of P in the sub scanning direction is T, the scan control unit causes sub scanning operations to be performed for (T×N−N) main scanning lines after the drum has been rotated N times.

24. The multibeam exposure scanning apparatus according to claim 18, further comprising:
a power control unit that controls powers of the beams,
wherein the power control unit controls the powers of the respective beams emitted from the emitting outlet row of only one level to become higher than the powers of the respective beams emitted simultaneously from the emitting outlet rows of all the levels.

25. The multibeam exposure scanning apparatus according to claim 20, further comprising:
a power control unit that controls powers of the beams,
wherein the power control unit controls the powers of the respective beams emitted from the emitting outlet row of only one level to become higher than the powers of the respective beams emitted simultaneously from the emitting outlet rows of all the levels.

26. The multibeam exposure scanning apparatus according to claim 22, further comprising:
a power control unit that controls powers of the beams,
wherein the power control unit controls the powers of the respective beams emitted from the emitting outlet row of only one level to become higher than the powers of the respective beams emitted simultaneously from the emitting outlet rows of all the levels.

27. The multibeam exposure scanning apparatus according to claim 18, further comprising:
a power control unit that controls powers of the beams,
wherein the power control unit controls the powers of the beams so that, in the second area, the powers of the beams emitted from the emitting outlets become lower toward the first area.

28. The multibeam exposure scanning apparatus according to claim 20, further comprising:
a power control unit that controls powers of the beams,
wherein the power control unit controls the powers of the beams so that, in the second area, the powers of the beams emitted from the emitting outlets become lower toward the first area.

29. The multibeam exposure scanning apparatus according to claim 22, further comprising:
a power control unit that controls powers of the beams,
wherein the power control unit controls the powers of the beams so that, in the second area, the powers of the beams emitted from the emitting outlets become lower toward the first area.

30. A method of manufacturing a printing plate, comprising
engraving a surface of a plate material by a multibeam exposure scanning method according to claim 14 to obtain a printing plate, the plate material being equivalent to the recording medium.
